(19) United States
(12) Patent Application Publication
(10) Pub. No.: US 2024/0237675 A1
(43) Pub. Date: Jul. 18, 2024

(54) TEXTURED PLANT PROTEINS WITH IMPROVED FIRMNESS

(71) Applicant: ROQUETTE FRERES, Lestrem (FR)

(72) Inventors: Cyril DROULEZ, Cambrin (FR); Anne MATIGNON, Lille (FR); Charlotte DLUBAK, ESTAIRES (FR); Anne-Sophie PETITPREZ, Lestrem (FR)

(21) Appl. No.: 18/574,226

(22) PCT Filed: Jun. 28, 2022
(86) PCT No.: PCT/EP2022/025292

§ 371 Date: Dec. 26, 2023

(30) Foreign Application Priority Data
Jun. 28, 2021 (FR) 2106921

(51) Int. Cl. A23J 3/26; A23J 3/14; A23J 3/22; A23L 11/00

(52) U.S. Cl. CPC A23J 3/26; A23J 3/14; A23J 3/227; A23L 11/05

(57) ABSTRACT

A specific composition comprising textured plant proteins, preferentially pea proteins, the firmness of which is greater than that of the similar products currently on the market, as well as to their method of manufacture and their use in food compositions, particularly meat analogues.

### PRIOR ART

The present invention relates to a specific composition comprising textured plant proteins, in particular textured oat proteins, textured rice proteins, or textured leguminous proteins, in particular chosen between pea and faba bean proteins, even more preferentially pea proteins, as well as to their manufacturing method and their use in food compositions, particularly meat analogs.

The technique for texturing proteins, especially by extrusion cooking, with the aim of preparing products with a fibrous structure intended for producing meat and fish analogs, has been applied to numerous plant sources.

The extrusion cooking processes for proteins can be separated into two large families by the amount of water used in the process. When this amount is greater than 30% by weight, this will be referred to as “wet” extrusion cooking, and the products obtained will be more intended for producing finished products for immediate consumption that simulate animal meat, for example, beef steaks or chicken nuggets. For example, patent application WO 2014/081285 is known, which discloses a method for extruding a mixture of protein and fibers using a cooling die typical of wet extrusion.

When this amount of water is less than 30% by weight, this is then referred to as “dry” extrusion cooking: the products obtained are more intended to be used by food-processing manufacturers, in order to formulate meat substitutes by mixing them with other ingredients. The field of the present invention is that of “dry” extrusion cooking.

Historically, the first proteins used as meat analogs were extracted from soybean and wheat. Soybean subsequently quickly became the main source for this field of applications.

Patent application WO 2009/018548 is known, for example, which teaches that various mixtures containing proteins can be extruded in order to generate an extruded protein with aligned fibers allowing the simulation of meat fibers to be contemplated.

While most of the studies that followed obviously related to soybean proteins, other sources of protein, both animal and plant, have been textured: peanut, sesame, cottonseed, sunflower, corn, wheat proteins, proteins derived from microorganisms, by-products from abattoirs or the fisheries industry.

Leguminous proteins, such as those derived from pea and faba bean, have also been the subject of work, both in terms of the isolation thereof and in terms of the “dry” extrusion cooking thereof.

Numerous studies have been undertaken on pea proteins given their particular functional and nutritional properties but also because of their non-genetically-modified nature.

Despite significant research efforts and increasing growth over recent years, the penetration of these products based on textured pea proteins on the food market is still subject to optimization. One of the reasons in particular lies in the texture, which is deemed less firm in comparison with the textured soybean proteins. This observation is shared for example in the article “Soy and Pea Protein and what in the word is TVP?” published on Dec. 26, 2018 by Eben Van Tonder and available at the following Internet link: https: //earthwormexpress.com/2018/12/26/soy-and-pea-protein-and-what-in-the-world-is-tvp/. The last table of this article thus shows, just before the conclusion section, a comparison of the various textured proteins according to their botanical origin. It can be clearly seen that the textured proteins obtained with isolates of pea or faba bean (“field bean”) are judged to be inferior from a texture standpoint compared to textured soybean proteins.

In spite of the significant research on these textured pea proteins, the textured pea proteins that have been developed and are available to date are always evaluated as being less firm than soybean proteins.

It is to the applicant's credit to have solved the above problems and to have developed a novel specific composition comprising oat, rice, pea and/or faba bean proteins, in particular pea proteins, obtained by dry extrusion cooking, whose firmness is increased relative to the textured pea proteins currently on the market.

This invention will be better understood in the following section which aims to disclose a general description thereof.

### GENERAL DESCRIPTION OF THE PRESENT INVENTION

The present invention relates to a method for producing a composition of plant proteins textured in a dry process, in particular oat proteins textured in a dry process, rice proteins textured in a dry process, or legume proteins textured in a dry process, in particular chosen between pea and faba bean proteins, even more preferentially pea proteins, characterized in that the method comprises the following steps:
1) Providing a mixture comprising a first material rich in plant proteins, in particular oat, rice or legume proteins in particular chosen from peas or faba beans, whose solubility in water at pH 7 and 20° C. is greater than or equal to 30% and a second material rich in plant proteins, in particular oats, rice or leguminous plants, the latter in particular being chosen from peas or faba beans, whose solubility in water at pH 7 and 20° C. is less than 30%, having a respective dry weight ratio of the first material rich in plant proteins to the second material rich in plant proteins ranging between 60/40 and 90/10, preferentially between 70/30 and 80/20;
2) Extrusion cooking said mixture with water, the water to mixture mass ratio before cooking ranging between 5% and 25%, preferentially between 5% and 20%, preferentially between 5% and 15%, preferentially between 10% and 15%, even more preferentially 10%.
3) Optionally cutting the extruded composition using a knife at the outlet of the extruder consisting of an outlet die with orifices,
4) drying the composition thus obtained.

According to a particular embodiment, the present invention relates to a method for producing a composition of legume proteins textured in a dry process, preferentially chosen between pea and faba bean proteins, characterized in that the method comprises the following steps:
1) Providing a mixture comprising a first material rich in proteins, preferentially peas or faba beans, whose solubility in water at pH 7 and 20° C. is greater than or equal to 30% and a second material rich in proteins, preferentially peas or faba beans, whose solubility in water at pH 7 and 20° C. is less than 30%, having a respective dry weight ratio of the first material rich in proteins to the second material rich in proteins ranging between 60/40 and 90/10, preferentially between 70/30 and 80/20,
2) Extrusion cooking said mixture with water, the water to mixture mass ratio before cooking ranging between 5% and 20%, preferentially between 10% and 15%, even more preferentially 10%,
3) Optionally cutting the extruded composition at the extruder outlet, consisting of an outlet die with orifices, using a knife,
4) drying the composition thus obtained.

Preferably, the legume protein is not a soybean protein.

Preferably, the mixture of step 1) also comprises plant fibers, in particular leguminous plants, with a dry weight ratio of material rich in plant proteins to plant fibers ranging between 70/30 and 90/10, preferentially between 75/25 and 85/15.

The mixture comprising materials rich in plant proteins and optionally plant fibers, in particular leguminous plants, in particular used in step 1, can be prepared by mixing said materials rich in plant proteins and fibers. The mixture may consist essentially of materials rich in plant proteins and leguminous fibers. The term “essentially consist of” means that the powder can comprise impurities associated with the method for producing materials rich in proteins and fibers, for example, traces of starch. Preferably, the leguminous plants from which the material rich in proteins and the fiber originate are selected from the list consisting of faba beans and peas. Pea is particularly preferred.

The present invention also relates to a composition comprising materials rich in plant proteins, preferentially chosen from oat, rice, pea and faba bean proteins, even more preferentially pea and faba bean, textured by dry extrusion in the form of particles, capable of being obtained by the method according to the invention

This is characterized in that its firmness measured with a test A is increased by at least 20%, preferentially at least 25%, even more preferentially at least 30% relative to the firmness of the compositions comprising materials rich in proteins, preferentially chosen between materials rich in oat, rice, pea and faba bean proteins, even more preferentially pea and faba beans, textured by dry extrusion available on the market.

A particular embodiment of the invention consists of a composition comprising only materials rich in pea proteins, textured by dry extrusion in the form of particles, the firmness of which according to a test A is greater than 12 kg, preferentially greater than 14 kg, 16 kg, 18 kg, 20 kg, 22 kg, 24 kg, 26 kg, 28 kg, 30 kg.

A particular embodiment consists of a composition comprising only materials rich in pea proteins, textured by dry extrusion in the form of particles, the firmness of which according to a test A is greater than 12 kg, preferentially greater than 14 kg, respectively, and the density of which according to a test D ranges between 70 g/L and 130 g/L, preferentially between 80 g/L and 120 g/L, preferentially between 90 g/L and 110 g/L

Another particular embodiment consists of a composition comprising only materials rich in pea proteins, textured by dry extrusion in the form of particles, the firmness of which according to a test A is greater than 25 kg, preferentially greater than 28 kg, respectively, and the density of which according to a test D is between 280 g/L and 320 g/L, preferentially between 290 g/L and 310 g/L

The protein content within the composition according to the invention ranges between 60% and 80%, preferentially between 70% and 80% by dry weight relative to the total weight of dry matter of the composition.

Finally, the dry matter of the composition according to the invention is greater than 80% by weight, preferentially greater than 90% by weight relative to the weight of said composition.

The content of calcium ions of the composition according to the invention is preferentially less than 0.5% by dry weight on dry weight, preferentially less than 0.45%, preferentially between 0.3% and 0.45%. The present invention lastly relates to the use of the protein composition according to the invention textured by dry extrusion as described above in industrial applications such as for example the human and animal food industry, industrial pharmaceuticals or cosmetics.

The present invention will be better understood upon reading the following detailed description.

### DETAILED DESCRIPTION OF THE PRESENT INVENTION

The present invention relates to a method for producing a composition of plant proteins textured in a dry process, in particular oat proteins in a dry process, rice proteins textured in a dry process, or legume proteins textured in a dry process, in particular chosen between pea and faba bean proteins, even more preferentially pea proteins, characterized in that the method comprises the following steps:
1) Providing a mixture comprising a first material rich in plant proteins, in particular oat, rice or legume proteins in particular chosen from peas or faba beans, whose solubility in water at pH 7 and 20° C. is greater than or equal to 30% and a second material rich in plant proteins, in particular oats, rice or leguminous plants, in particular chosen from peas or faba beans, whose solubility in water at pH 7 and 20° C. is less than 30%, having a respective dry weight ratio of the first material rich in plant proteins to the second material rich in plant proteins ranging between 60/40 and 90/10, preferentially between 70/30 and 80/20;
2) Extrusion cooking said mixture with water, the water to mixture mass ratio before cooking ranging between 5% and 25%, preferentially between 5% and 20%, preferentially between 5% and 15%, preferentially between 10% and 15%, even more preferentially 10%,
3) Optionally cutting the extruded composition using a knife
4) drying the composition thus obtained.

“Material rich in plant proteins” is understood to mean a material comprising at least 25% of proteins, in particular any powder, solution, flake containing at least 25% proteins. Mention may be made, in a non-limiting manner, of flours, concentrates, isolates, seeds.

For the purposes of the present invention, the term “protein composition” refers to a composition comprising materials rich in proteins.

Preferably, the proteins used for step 1 are selected from the list consisting of oat, rice, faba bean and pea protein, preferably chosen from the list consisting of faba bean and pea protein. The use of pea protein alone is particularly preferred. The use of faba bean protein alone or of a faba bean/pea mixture is, however, possible. The use of oat protein alone or of an oat/pea mixture is, however, possible. The use of rice protein alone or of a rice/pea mixture is, however, possible

Even more preferably, the materials rich in plant proteins used for step 1 are characterized as isolates, that is, their richness in protein is greater than 80% (the analysis described in paragraph 37 being usable to do this). The use of concentrates (protein content between 50% and 80%) or even flour (protein content less than 50%) is possible, but not preferred.

In a particular embodiment, the plant proteins used within the scope of the invention do not include soybean proteins. In this embodiment, materials rich in soybean proteins are therefore excluded from the invention. This is in particular due to their referential position from a firmness point of view. Thus, in this embodiment, when the plant protein composition is a composition of leguminous plants, the composition is not a composition of soybean proteins.

The solubilities of the materials rich in proteins are measured using Test B below:

150 g of distilled water are introduced into a 400 ml beaker at 20° C.+/−2° C. by stirring with a magnetic stirrer bar, and precisely 5 g of legume protein sample to be tested are added. If required, the pH is adjusted to the desired value, that is, 7, with 0.1 N NaOH. The content is supplemented with water to reach 200 g of water. Mixing is carried out for 30 minutes at 1000 rpm and centrifugation is carried out for 15 minutes at 3000 g. 25 g of the supernatant are collected and introduced into a crystallizing dish dried and tared beforehand. The crystallizing dish is placed in an oven at 103° C.±2° C. for 1 hour. It is then placed in a desiccator (with desiccant) to cool to ambient temperature, and is weighed.

The solubility corresponds to the content of soluble dry matter, expressed as % by weight relative to the weight of the sample. The solubility is calculated with the following formula:

$$\% solubility = \frac{( m 1 - m 2 ) \times ( 200 + P )}{P 1 \times P} \times 100 \qquad [ Math . 1 ]$$

where:
P=weight, in g, of the sample=5 g
m1=weight, in g, of the crystallizing dish after drying
m2=weight, in g, of the empty crystallizing dish
P1=weight, in g, of the sample collected=25 g

Obtaining materials rich in pea or faba bean protein having a solubility in water at pH 7 of greater than or equal to 30% is easy with the conventional methods of the art well known to a person skilled in the art. Mention will be made, for example, of the processes described in patent applications EP1909593 or FR2018052261 of the applicant. It is in fact conventional to obtain a material rich in pea or faba bean protein with a solubility in water at pH 7 of greater than or equal to 30%. The basic principle of these methods (suspending pea flour in water by wet or dry milling, removing the insoluble parts such as starch and internal fibers by centrifugation, isoelectric precipitation of the protein of interest) is now conventional and very easily proposes an appropriate protein.

Obtaining materials rich in oat protein having a solubility in water at pH 7 of greater than or equal to 30% is easy with the conventional methods of the art well known to a person skilled in the art. Mention will be made, for example, of the method described in patent application WO 2020/193641 of the applicant.

Obtaining a material rich in pea or faba bean protein having a solubility in water at pH 7 of less than 30% is less easy, although any method resulting in such a protein is acceptable. Mention may be made, for pea protein, of patent EP2911524, or for faba bean protein, of patent application WO2020/193668. Chemical and/or thermal denaturation of a protein can also be envisaged.

Obtaining materials rich in oat protein having a solubility in water at pH 7 of less than 30% remains easy with the conventional methods of the art well known to a person skilled in the art. Mention will be made, for example, of the method described in patent application WO2021/001478 of the applicant.

It is quite unusual for a person skilled in the art of extrusion to have thought to use a material rich in plant protein to the exclusion of soybean, preferentially chosen from oats, rice, peas or faba beans, which are not very soluble for extrusion. It will be noted that in patent application WO2017129921 the use of NUTRALYS® BF (whose solubility at pH 7 and 20° C. is less than 30%) is described as to be avoided in extrusion. Likewise, in application WO2020123585, the use of a NUTRALYS® BF in extrusion to produce dry textures to produce meat analogs does not result in good fibration.

This is undoubtedly explained by the fact that low solubility also generates low functional powers, particularly a low gelling power. Such an afunctional protein will therefore be difficult to modify by extrusion in order to form a fibrous network.

Preferably, the material rich in protein, preferably in oat, rice, pea or faba bean protein, having a solubility in water at pH 7 and 20° C. of less than 30%, is characterized in that its water retention capacity is less than 4 grams per gram of material rich in proteins.

The water retention capacity is determined very simply by double weighing. 10 grams of dry weight of protein composition in powder form is taken, which is placed in excess water for 30 minutes. The whole is dried so as to evaporate the water completely (until no significant evolution of the mass of the product is observed). The remaining mass of product is then weighed. The water adsorption capacity is expressed in g of water adsorbed per gram of initial dry product.

Preferably, the materials rich in plant proteins, preferentially oat, rice or leguminous plants chosen from pea proteins and faba bean proteins, are characterized by a protein content advantageously ranging between 60% and 90%, preferentially between 70% and 85%, even more preferentially between 75% and 85% by weight to the total dry matter. Any method well known to a person skilled in the art can be used to analyze this protein content. Preferably, the total nitrogen amount will be assayed using well-known Kjeldhal or Dumas methods and this content will be multiplied by the coefficient 6.25. This method is particularly known and used for plant proteins. Preferably, the dry matter of the material rich in leguminous protein is more than 80% by weight, preferentially more than 90% by weight.

Even more preferably, the materials rich in plant proteins are characterized by a particle size characterized by a Dmode ranging between 150 microns and 400 microns, preferentially between 150 microns and 200 microns or between 350 microns and 450 microns. The measurement of this particle size is carried out using a MALVERN 3000 laser particle size analyzer in the dry phase (equipped with a powder module). The powder is placed in the feeder for the module with an opening ranging between 1 and 4 mm and a vibration frequency of 50% or 75%. The device automatically records the various sizes and adjusts the Particle Size Distribution (or PSD) as well as the Dmode, D10, D50 and D90. The Dmode is well known to a person skilled in the art and consists of the average size of the largest population of particles by number.

The particle size of the powder is advantageous for the stability and the productivity of the method. An excessively fine particle size is irrevocably followed by problems that are sometimes difficult to manage during the extrusion method.

It is possible to complement the oat, rice, pea or faba bean proteins with amino acids, other proteins such as proteins derived from cereals or else pea and faba bean albumins, in order to supplement the amino acid profile and obtain proteins whose PDCAAS (for “Protein Digestibility Corrected Amino Acid Score”) and DIAAS (for “Digestible Indispensable Amino Acid Score”) is increased, or even a PDCAAS equal to 1. Such an addition will have to be minor and not alter the initial solubility of the proteins.

Preferably, the mixture of step 1) also comprises plant fibers, in particular leguminous plants or potato, in particular leguminous plants with a dry weight ratio of plant proteins/plant fibers ranging between 70/30 and 90/10, preferentially ranging between 75/25 and 85/15.

“Plant fiber” or “leguminous fiber” is understood to mean any compositions comprising polysaccharides that are relatively indigestible or indigestible by the human digestive system, extracted from leguminous plants. Such fibers are extracted using any method that is well known to a person skilled in the art. Pea, faba bean or potato are particularly preferred as plant fiber sources.

The mixture comprising plant proteins, with or without fibers, in particular leguminous plants, used in step 1 can be prepared by mixing said materials rich in proteins and fibers according to the mixture prepared. The powder can essentially consist of materials rich in proteins, in particular leguminous proteins and leguminous fibers, in particular leguminous plants. The term “essentially consist of” means that the powder can comprise impurities associated with the method for producing materials rich in proteins and fibers, for example, traces of starch. Mixing involves obtaining a dry mixture of the various constituents required to synthesize the plant fiber during step 2.

Preferably, the leguminous fiber is derived from a pea using a wet extraction method. The dehulled pea is reduced to flour, which is then suspended in water. The suspension thus obtained is sent to hydrocyclones in order to extract the starch. The supernatant is sent to horizontal settling tanks in order to obtain a leguminous fiber fraction. Such a method is described in patent application EP 2950662. A leguminous fiber thus prepared contains between 40% and 60% of polymers made up of cellulose, hemicellulose and pectin, preferably between 45% and 55%, as well as between 25% and 45% of pea starch, preferably between 30% and 40%. A commercial example of such a fiber is, for example, the Pea Fiber I50 fiber by Roquette.

The mixing can be carried out upstream using a dry mixer or even directly as a feed from step 2. During this mixing, additives can be added that are well known to a person skilled in the art, such as flavorings or even dyes.

In an alternative embodiment, the fiber/protein mixture is naturally obtained by turboseparation of a leguminous flour. The leguminous plant seeds are cleaned, their outer fibers are removed, and they are ground to flour. The flour is then turboseparated, which consists in applying a rising stream of air, enabling the different particles to be separated based on their density. This thus makes it possible to concentrate the content of proteins in the flours from approximately 20% to more than 60%. Such flours are called “concentrates”. These concentrates also contain between 10% and 20% of leguminous fibers.

The dry weight ratio between materials rich in plant proteins and fibers is advantageously between 70/30 and 90/10, preferentially between 75/25 and 85/15.

During step 2, this mixture will then be textured, which is the same as saying that the materials rich in proteins and the fibers will undergo thermal destructuring and reorganization in order to form fibers with continuous elongation in straight, parallel lines, simulating the fibers present in meats. Any method well known to a person skilled in the art will be suitable, in particular extrusion.

Extrusion consists in forcing a product to flow through a small hole, the die, under the action of high pressures and shearing forces, using the rotation of one or two Archimedes screws. The resulting heating causes cooking and/or denaturing of the product, hence the term sometimes used, “extrusion cooking”, then expansion by evaporation of the water at the die outlet. This technique makes it possible to develop products which are widely varied in their composition, their structure (expanded and alveolar form of the product), and their functional and nutritional properties (denaturing of anti-nutritional or toxic factors, sterilization of food, for example). Processing of proteins often leads to structural modifications which are reflected by obtaining products with a fibrous appearance, simulating animal meat fibers.

Step 2 must be carried out with a water to mixture mass ratio before cooking ranging between 5% and 25%, preferentially between 5% and 20%, preferentially between 5% and 15%, preferentially between 10% and 15%, even more preferentially 10%. This ratio is obtained by dividing the amount of water by the amount of mixture, and by multiplying by 100. Preferably, the water is injected at the feeding zone, following the zone for introducing the mixture and before the kneading zone. Any drinking water is suitable for this purpose. “Drinking water” is understood to mean water that can be drunk or used for domestic and industrial purposes without posing health risks.

Preferentially, its conductivity is selected between 400 and 1,100, preferentially between 400 and 600 μS/cm. More preferably in the present invention, it will be understood that this drinking water has a sulfate content of less than 250 mg/l, a chloride content of less than 200 mg/l, a potassium content of less than 12 mg/l, a pH ranging between 6.5 and 9 and a total hardness (TH, namely the hardness of the water, corresponding to the measurement of the calcium and magnesium ions content in water) of more than 15 French degrees. In other words, drinking water must not have less than 60 mg/l of calcium or 36 mg/l of magnesium. This definition includes water from the drinking water network, decarbonated water, demineralized water.

Without being bound by any theory, it is well known to a person skilled in the art of extrusion cooking that it is this water to mixture mass ratio that will allow the required density to be obtained. The values of this ratio therefore will potentially be 5, 6, 7, 8, 9, 10, 11, 12, 13, 14, 15, 16, 17, 18, 19, 20, 21, 22, 23, 24 or 25%.

Preferably, step 2 is carried out by extrusion cooking in a twin-screw extruder characterized by a length to diameter ratio ranging between 20 and 65, preferentially between 20 and 45, preferentially between 35 and 45, preferentially 40, and equipped with a series of 85-95% feeding elements, 2.5-10% kneading elements, and 2.5-10% reverse pitch elements.

The length to diameter ratio is a conventional parameter in extrusion cooking. This ratio therefore can be 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64 or 65.

The various elements are the feeding elements intended for feeding the product into the die without modifying the product, the kneading elements intended for mixing the product and the reverse pitch elements intended for applying a force to the product to cause it to advance in the opposite direction and thus cause mixing and shearing.

Preferably, the feeding elements will be placed at the very beginning of the screw with a temperature set between 20° C. and 70° C., then the kneading elements and the reverse pitch elements with temperatures ranging between 90° C. and 150° C.

Preferably, this screw is rotated between 800 and 1150 revolutions/min, preferentially between 850 and 900 revolutions/min.

Even more preferably, a specific power ranging between 15 and 30 Wh/kg, preferentially between 10 and 25 kWh/kg is applied to the powder mixture, by regulating the pressure at the outlet in a range ranging between 60 and 100 bars, preferentially between 70 and 90 bars.

Step 3 then consists in an optional cutting of the extruded composition using a knife. At the outlet of the extruder (consisting of an outlet die with orifices, preferentially having a diameter of 3 mm), it is therefore preferentially possible to cut the extruded composition using a knife whose speed of rotation is preferentially between 1,000 and 1,500 revolutions per minute. If a knife is not used, the extruded composition will naturally be cut by the extrusion method implemented, during ejection of the extruded protein at the extruder outlet.

The knife is placed flush with the outlet of the extruder, preferentially at a distance of between 0 mm and 5 mm. “Flush” is understood to be at a distance extremely close to the die located at the outlet of the extruder, at the limit of touching the die but without touching it. Conventionally, a person skilled in the art will adjust this distance by making the knife and the die touch each other, then by shifting the latter very slightly.

The last step 4 involves drying the composition thus obtained.

A person skilled in the art will know how to use the appropriate technology in order to dry the composition according to the invention from the wide selection currently available to them. Without limitation and solely by way of an example, air flow dryers, microwave dryers, fluidized bed dryers or vacuum dryers can be cited. A person skilled in the art will select the correct parameters, mainly the time and temperature, in order to achieve the desired final dry matter.

The present invention also relates to a composition comprising materials rich in plant proteins, preferentially chosen from oat, rice, pea and faba bean proteins, in particular pea and faba bean proteins, textured by dry extrusion in the form of particles, capable of being obtained by the method according to the invention.

The materials rich in plant proteins are in particular chosen from the list consisting of oat, rice, faba bean protein and pea protein. The use of pea protein alone is particularly preferred. A mixture of pea and faba bean, pea and oat, pea and rice, faba bean and oat, or entirely based on faba bean or oats can also be envisaged.

The term “leguminous” is considered herein to mean the family of dicotyledonous plants of the order Fabales. This is one of the largest flowering plant families, third after Orchidaceae and Asteraceae in terms of number of species. It contains approximately 765 genera, bringing together more than 19,500 species. Several leguminous plants are important crop plants, including soybean, beans, peas, faba beans, chickpeas, peanuts, cultivated lentils, cultivated alfalfa, various clovers, broad beans, carob and licorice.

In the context of the present invention, soybean is in particular excluded from the list of leguminous plants of interest to carry out the invention.

The term “pea” is considered here in its broadest accepted use and includes in particular all the varieties of “smooth pea” and “wrinkled pea” and all the mutant varieties of “smooth pea” and “wrinkled pea”, regardless of the uses for which said varieties are usually intended (human food, animal feed and/or other uses).

The term “pea” in the present application includes pea varieties belonging to the Pisum genus and more particularly to the species sativum and aestivum. Said mutant varieties are in particular those called “r mutants,” “rb mutants,” “rug 3 mutants,” “rug 4 mutants,” “rug 5 mutants” and “lam mutants” as described in the article by C-L HEYDLEY et al. Titled “Developing novel pea starches” Proceedings of the Symposium of the Industrial Biochemistry and Biotechnology Group of the Biochemical Society, 1996, pp. 77-87.

“Faba bean” is intended to mean the group of annual plants of the species Vicia faba, belonging to the group of leguminous plants of the Fabaceae family, Faboideae subfamily, Fabeae tribe. A distinction is made between Minor and Major varieties. In the present invention, wild-type varieties and those obtained by genetic engineering or varietal selection are all excellent sources.

Within the meaning of the present application, “oats” means a cereal plant belonging to the botanical genus Avena. This genus can be divided into wild-type and cultured species, which have been cultivated for thousands of years as a source of food for humans and livestock. The cultured species contain:
Avena sativa—the most commonly cultivated species, commonly called “oats.”
Avena abyssinica—Ethiopian oats, originating from Ethiopia, from Eritrea and Djibouti; natural to Yemen and Saudi Arabia
Avena byzantina, a minor crop in Greece and the Middle East; introduced into Spain, Algeria, India, New Zealand, South America, etc
Avena nuda—bare oats or unhulled oats, which have roughly the same role in Europe as A. abyssinica in Ethiopia. It is sometimes included in A. sativa and was widely grown in Europe before the latter replaced it. Since its nutrient content is slightly better than that of common oats, A. nuda has become more significant in recent years, especially in organic farming.
Avena strigosa—lopsided oats, bristle oats or black oats, cultivated as a forage crop in some parts of the Western Europe and Brazil.

If the materials rich in leguminous plant proteins, in particular derived from oats, rice, faba beans and peas, more particularly derived from faba beans and peas, are particularly adapted to the design of the invention, it is nevertheless possible to achieve the latter with other sources of materials rich in plant proteins such as oat, mung bean, potato, corn or even chickpea protein. A person skilled in the art will know how to make any necessary adjustments.

“Extrusion,” “textured” or “texturing” in the present application is understood to mean any physical and/or chemical process that aims to modify a composition comprising proteins in order to give it a specific ordered structure. Within the scope of the invention, texturing proteins aims to give the appearance of a fiber, such as those present in animal meats. As is described throughout this description, a particularly preferred method for texturing proteins is extrusion cooking, particularly using a twin-screw extruder.

The composition of materials rich in proteins, which may be obtained by the method according to the invention, is characterized in that its firmness measured with a test A is increased by at least 20%, preferentially at least 25%, even more preferentially at least 30% relative to the firmness of the compositions comprising proteins, preferentially chosen between pea and faba bean proteins, textured by dry extrusion available on the market.

In order to measure the firmness of the composition according to the invention, test A is used, the protocol of which is described below:
a. Weigh 20 g of sample to be analyzed into a beaker
b. Add demineralized water at ambient temperature (temperature between 10° C. and 20° C., preferentially 20° C. +/−1° C.)
c. Leave in static contact for 5 minutes by placing a 250 g weight on the sample to ensure that it is immersed;
d. Separate residual water and the rehydrated sample using a sieve making it possible to separate the sample and the residual water;
e. Deposit the rehydrated sample at the bottom of an Ottawa cell (cell in the form of a standard plexiglas block, with a volume of 440 ml), equipping a TA.HD plusC Texture Analyzer texturometer connected to the Exponent Connect Version 7.0.4.0 software, and equipped with a 50 kg force sensor (“load cell”)
f. Start the analysis with the following parameters: pre-test speed=1 mm/s, test speed=5 mm/s, post-test speed=10 mm/s, strain=50%, trigger force=750 kg;

The firmness value corresponds to the maximum force (expressed in kg) obtained during the analysis (3 repetitions are carried out and the arithmetic mean is calculated)

“Demineralized water” is understood to mean water that has undergone a treatment aimed at removing a certain amount of its minerals. Preferentially, its conductivity is less than 100 μS/cm, preferentially less than 50 μS/cm, even more preferentially between 10 and 40 μS/cm.

As indicated above, the textured soybean protein compositions of the prior art are already well known and used in the food industry, in particular in meat analogs. Their firmness is judged to be significantly greater than that of the textured pea or faba bean proteins of the prior art, as is described in the article the article “Soy and Pea Protein and what in the word is TVP?” published on Dec. 26, 2018 by Eben Van Tonder. It is to the credit of the present Applicant to have worked on this subject and demonstrated that the method described in the present application makes it possible to obtain a plant protein such as textured pea, oat or faba bean, the firmness of which is equivalent to that of the textured soybean proteins.

A particular embodiment of the invention consists of a composition comprising only materials rich in pea proteins, textured by dry extrusion in the form of particles, the firmness of which according to a test A is greater than 12 kg, preferentially greater than 14 kg, 16 kg, 18 kg, 20 kg, 22 kg, 24 kg, 26 kg, 28 kg, 30 kg.

A particular embodiment consists of a composition comprising only materials rich in pea proteins, textured by dry extrusion in the form of particles, the firmness of which according to a test A is greater than 12 kg, preferentially greater than 14 kg, respectively, and the density of which according to a test D ranges between 70 g/L and 130 g/L, preferentially between 80 g/L and 120 g/L, preferentially between 90 g/L and 110 g/L

Another particular embodiment consists of a composition comprising only materials rich in pea proteins, textured by dry extrusion in the form of particles, the firmness of which according to a test A is greater than 25 kg, preferentially greater than 28 kg, respectively, and the density of which according to a test D is between 280 g/L and 320 g/L, preferentially between 290 g/L and 310 g/L. Preferably, the dry matter content of the composition according to the invention is greater than 80% by weight, preferentially greater than 90% by weight.

The dry matter is measured using any method that is well known to a person skilled in the art. Preferably, the “desiccation” method is used. It involves determining the amount of water evaporated by heating a known amount of a sample of known mass. Heating is continued until the mass stabilizes, indicating that the water has evaporated completely. Preferably, the temperature used is 105° C.

The protein content of the composition according to the invention advantageously ranges between 60% and 80%, preferentially between 70% and 80% by weight relative to the total dry matter. Any method well known to a person skilled in the art can be used to analyze this protein content. Preferably, the total nitrogen amount will be assayed and this content will be multiplied by the coefficient 6.25. This method is particularly known and used for plant proteins.

Even more preferably, the content of calcium ions of the composition according to the invention is preferentially less than 0.5% by dry weight on dry weight, preferentially less than 0.45%, preferentially between 0.3% and 0.45%.

According to a particular embodiment, the density or mass density of the composition according to the invention is between 60 and 320 g/L, preferentially between 70 and 280 g/L.

Preferably, the density or mass density of the composition the invention is between 60 and 150 g/L, preferentially between 70 and 130 g/L.

According to another embodiment, the density or mass density of the composition according to the invention is between 280 and 320 g/L, preferentially between 290 and 310 g/L.

To measure this density, the following protocol, called Test D, is used:
Tare a 2 liter graduated cylinder;
Fill the cylinder with the product to be analyzed. It is sometimes necessary to pack down using small taps on the wall of the cylinder, in order to be sure that the product fills the 2 liter volume.
Weight the product (Weight P (in grams).

Density=(P(g)/2(L)).

Preferably, the water retention measured according to Test C ranges between 1 and 2.5, preferentially between 1 and 2

In order to measure the water holding capacity, test C is used, the protocol of which is described below:
a. Weigh 40 g of sample to be analyzed into a beaker
b. Add demineralized water at ambient temperature (20° C. +/−1° C.) until the sample is completely submerged;
c. Leave in static contact for 30 minutes;
d. Separate residual water and the sample using a sieve making it possible to separate the sample and the residual water;
d. Weigh the final weight P (in grams) of the rehydrated sample;

The computation for water holding capacity, expressed as grams of water per gram of protein analyzed, is as follows:

$$Water holding capacity = ( P - 40 ) / 40 .$$

Finally, the present invention relates to the use of the composition of materials rich in plant proteins, preferentially from oats or leguminous plants textured in a dry process as described above in industrial applications such as, for example, the human and animal food industry, industrial pharmaceuticals or cosmetics.

The human and animal food industry is understood to mean industrial confectionery (for example, chocolate, caramel, jelly sweets), bakery products (for example, bread, brioches, muffins), the meat and fish industry (for example, sausages, hamburgers, fish nuggets, chicken nuggets), sauces (for example, bolognaise, mayonnaise), products derived from milk (for example, cheese, plant milk), beverages (for example, high protein beverages, powdered beverages to be reconstituted).

In general, the composition according to the invention can be used in food products at a content ranging up to 100% by weight relative to the total dry weight of the food, for example, by an amount from about 1% by weight to about 80% by weight relative to the total dry weight of the food or beverage. All intermediate amounts (i.e. 2%, 3%, 4% . . . 77%, 78%, 79% by weight relative to the total weight of the food or beverage) are envisaged, as well as all the intermediate ranges based on these quantities. The food products that can be envisaged in the context of the present invention comprise baked products; baked products (including, but not limited to, rolls, cakes, pies, pastries, and cookies); pre-made sweet baking mixtures for preparing sweet baked products; pie fillings and other sweet fillings (including, but not limited to, fillings for fruit pies and fillings for nut pies, such as fillings for pecan pies, as well as fillings for biscuits, cakes, pastries, confectionery products and similar products, such as fillings for fat-based cream); desserts, gelatins and puddings; frozen desserts (including, but not limited to, frozen dairy desserts such as ice cream—including ordinary ice cream, soft serve ice cream and all other types of ice cream—and non-dairy frozen desserts such as non-dairy ice cream, sorbet and similar products); carbonated beverages (including, but not limited to, carbonated soft drinks); non-carbonated beverages (including, but not limited to, non-carbonated soft drinks such as flavored beverages), fruit juices and sweetened beverages); beverage concentrates (including, but not limited to, liquid concentrates and syrups as well as non-liquid concentrates, such as freeze-dried and/or powdered preparations); yogurts (including, but not limited to, high-fat, reduced-fat and fat-free dairy yogurts, as well as non-dairy and lactose-free yogurts and the frozen equivalents of all of these products); snack bars (including, but not limited to, cereal bars, nut bars, grain bars and/or fruit bars); bread products (including, but not limited to, yeasted and unyeasted breads, yeasted and unyeasted breads such as soda breads, breads comprising any type of wheat flour, breads composed of any type of non-wheat flower (such as potato, rice and rye flour), gluten-free bread); mixtures of pre-prepared bread for preparing bread products; sauces, syrups and vinaigrettes; sweetened spreads (including, but not limited to, jellies, jams, butters, nut spreads and other spreadable preserves, preserves and other similar products); confectionery products (including, but not limited to, jelly beans, soft candies, hard candies, chocolates and gums); sugar-coated and not sugar-coated, breakfast cereals (including, but not limited to, extruded breakfast cereals, flaked breakfast cereals and blown breakfast cereals) and coating compositions for cereals intended for the preparation of sweet breakfast cereals. Other types of food and beverage products that are not mentioned herein but which usually comprise one or more nutritive sweeteners can also be envisaged in the context of the present invention. In particular, animal feed (such as pet food) is explicitly envisaged. It can also be used, after texturing by extrusion, in meat products such as emulsified sausages or veggie burgers. It can also be used in egg replacement formulations.

The pea protein composition can be used as a single source of proteins, but can also be used in combination with other plant or animal proteins. The term “plant protein” denotes all the proteins derived from cereals, oleaginous plants, leguminous plants and tuberous plants, as well as all the proteins derived from algae and microalgae or fungi, used alone or as a mixture, selected from the same family or from different families. In the present application, the term “cereals” refers to plants cultivated from the family of grasses producing edible grains, for example wheat, rye, barley, corn, sorghum or rice. Grain are often ground in flour form, but are also provided in the form of cereals and sometimes in the form of whole plants (forage crops). In the present application, the term “tubers” covers the storage members, generally underground, which ensure the survival of the plants in the winter and often their multiplication by the vegetative process. These members are bulbous due to the accumulation of storage substances. The members transformed into tubers may be the root, e.g. carrot, parsnip, cassava, konjac), rhizome (e.g. potato, Jerusalem artichoke, Japanese artichoke, sweet potato), the base of the stem (more specifically the hypocotyl, e.g. kohlrabi, celery root), the root and hypocotyl combination (e.g., beetroot, radish). For the purposes of the present invention, the term “leguminous plants” refers to any plant belonging to the family of Cesalpiniaceae, to the family of Mimosaceae or to the family of Papilionaceae, and in particular: all plants belonging to the family of Papilionaceae, for example peas, beans, soybeans, beans, green beans, green beans, lentils, alfalfa, clover or lupin. This definition comprises in particular all the plants described in one of the tables from the article by R. HOOVER et al., 1991 (Hoover R. (1991) “Composition, structure, functionality and chemical modification of legume starches: a review,” Can. J. Physiol. Pharmacol., 69, p. 79-92). Animal proteins can, for example, be egg or milk proteins, such as whey proteins, casein or caseinate proteins. The pea protein composition can therefore be used in combination with one or more of these proteins or amino acids in order to improve the nutritional properties of the final product, for example to improve the PDCAAS of the protein or to provide others or to modify

More preferably, the present invention relates to the use of the composition of materials rich in plant proteins, in particular oats or leguminous plants, textured in a dry process as described above in the field of baking.

The invention will be of particular interest in order to produce inclusions in bakery products such as muffins, cookies, cakes, bagels, pizza dough, breads and breakfast cereals.

The term “inclusions” is understood to mean particles (in this case the composition of plant proteins textured in a dry process) mixed with a dough before it is cooked. After this step, the composition of plant proteins textured in a dry process is trapped in the final product (hence the term “inclusion”) and provides both its protein content as well as crunchiness when consumed.

The invention will be of particular interest in order to produce inclusions in confectionery products such as fat filings, chocolates, so as to also provide protein retention as well as crunchiness.

The invention will be of particular interest in order to produce inclusions in products that are alternatives to dairy products such as cheeses, yogurts, ice creams and beverages.

The invention will be of particular interest in the field of analogs of meat, fish, sauces, soups.

A particular application relates to the use of the composition according to the invention to manufacture a meat substitute, in particular of ground meat, but also of bolognese sauce, steak for hamburger, meat for tacos and pita, “chili sin carne.”

In pizzas, the composition comprising textured leguminous proteins according to the invention will be of particular interest for being sprinkled on top of said pizza (“topping”).

In dehydrated ready meals (for example, Bolino in Europe or Good Dot in India), the textured composition according to the invention will be used as an element providing fibrous texture and protein. Thus, a product can be obtained that hydrates quickly and to its core, while being pleasing to chew.

The invention will be better understood upon reading the Figure and the following non-limiting examples.

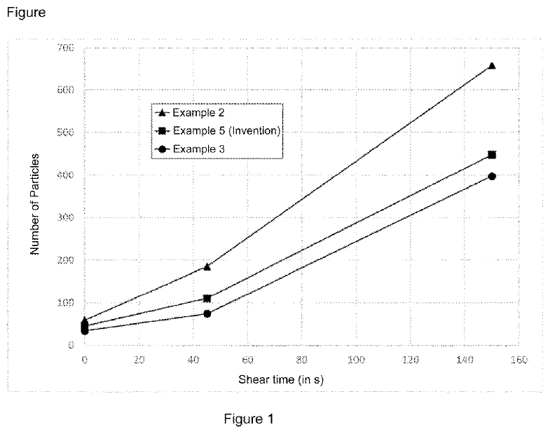

FIG. 1 shows the results obtained in a shear strength test according to Example 3; the x-axis depicts the shear time expressed in seconds, the y-axis depicts the number of particles.

### Examples

The following examples will be used:
The NUTRALYS® F85G (from ROQUETTE) as pea protein isolate whose solubility at pH 7 and 20° C. is greater than 30%
   Richness in protein=83.9%
   Dry matter=93.4%
   Solubility in water at pH 7 and 20° C.=50.8%
   Calcium content=0.07%
The NUTRALYS® F85M (from ROQUETTE) as pea protein isolate whose solubility at pH 7 and 20° C. is greater than 30%
   Richness in protein=84.1%
   Dry matter=94.3%
   Solubility in water at pH 7 and 20° C.=52.8%
   Calcium content=0.08%
The NUTRALYS BF (from ROQUETTE) as pea protein isolate whose solubility at pH 7 and 20° C. is less than 30%
   Richness in protein=82.4%
   Dry matter=93.2%
   Solubility in water at pH 7 and 20° C.=10.1%
   Calcium content=1.4%

Description of the common part of the method for producing a composition of leguminous proteins textured in a dry process used for all the examples

This description is general to all of the tests/examples. The particularities (composition, flow rates, settings, will be specified in Table 1 below)

The powder mixture is introduced by gravity into a LEISTRITZ twin-screw extruder (L/D=60, with 15 sheaths) from the company COPERION.

The mixture is introduced with a flow rate regulated in kg/h. A regulated amount of water in kg/h is also introduced. A water to powder mass ratio is therefore calculated and expressed in %.

The extrusion screw, made up of 85% feeding elements, 5% kneading elements and 10% reverse pitch elements, is rotated at a speed regulated in rpm and sends the mixture to a die. As indicated in the description, the feeding elements have been placed at the very beginning of the screw with a temperature set between 20° C. and 70° C., then the kneading elements and the reverse pitch elements with temperatures ranging between 90° C. and 150° C.

This particular procedure generates a machine torque expressed in % with an outlet pressure read in bars. The specific energy of the system is calculable (according to the conventional knowledge of a person skilled in the art) and expressed in KWh/Kg

The product is directed at the outlet toward a die made up of 1×3 mm cylindrical hole, from which the textured protein is expelled, which is then cut using knives rotating at between 1,200 and 1,500 revolutions/minute placed flush with the outlet of the extrusion die.

The textured protein thus produced is dried in a Thermo Scientific model UT6760 ventilated oven heated to 60° C.

The measurements of the water holding capacity according to test C and of the density of the extruded protein using test D are recorded.

### A) Examples Dedicated to Materials Rich in Pea Proteins

### Example 1: Synthesis of the Different Tests Carried Out to Obtain Low-Density Textured Compositions

Table 1 below summarizes the various tests carried out as well as the analyses corresponding to the compositions obtained.

TABLE 1

| | | Prior art | | | Invention | | Calcium effect | |
|---|---|---|---|---|---|---|---|---|
| | | Ex. 1 | Ex. 2 | Ex. 3 | Ex. 4 | Ex. 5 | Ex. 6 | Ex. 7 |
| Composition | Internal pea fibers (PEA | 12.4 | 12.4 | 12.4 | 12.4 | 12.4 | 12.2 | 11.85 |
| (quantities | FIBER 150M) | | | | | | | |
| expressed as | Soluble pea protein isolate | 0 | 0 | 0 | 0 | 0 | 87.3 | 0 |
| percentage | (NUTRALYS F85M) | | | | | | | |
| by weight | Soluble pea protein isolate | 87.6 | 87.6 | 0 | 61.3 | 61.3 | 0 | 87.15 |
| of the total | (NUTRALYS F85G) | | | | | | | |
| mass of the | Insoluble pea protein | 0 | 0 | 87.6 | 26.3 | 26.3 | 0 | 0 |
| powder mixture | isolate (NUTRALYS BF) | | | | | | | |
| feeding the | Calcium carbonate | 0 | 0 | 0 | 0 | 0 | 0.5 | 1 |
| extruder) | Calcium chloride | 0 | 0 | 0 | 0 | 0 | 0 | 0 |
| Extrusion | Powder flow rate (kg/h) | 35 | 35 | 35 | 35 | 35 | 35 | 35 |
| settings | Water flow rate (kg/h) | 6.9 | 5 | 4.7 | 4.2 | 4.5 | 5.8 | 6.4 |
| | Screw Speed (in rpm) | 1150 | 900 | 900 | 1150 | 900 | 1150 | 1150 |
| | Torque (%) | 36 | 42 | 45 | 40 | 43 | 37 | 36 |
| | Pressure (bar) | 81 | 93 | 100 | 80 | >100 | 70 | 75 |
| | Specific energy (in kWh/kg) | 26.6 | 25 | 26 | 30 | 26 | 27 | 26 |
| | Knife rotation speed (in | 1100 | 1500 | 1000 | 1400 | 1100 | 1500 | 1500 |
| | rpm) | | | | | | | |
| Textured | Calcium (in %/dry) | 0.07 | 0.07 | 0.4 | 0.4 | 0.5 | 0.2 | 0.4 |
| protein | Density (g/L) according to | 110 | 100 | 90/121 | 100 | 110 | 80 | 90 |
| analyses | Test D | | | | | | | |
| | Firmness according to Test | 11.06 | 11.2 | 15.01 | 15.6 | 12.7 | 10.07 | 9.52 |
| | A (Kg) | | | | | | | |
| | Water holding according to | 3.68 | 3.31 | 1.74 | 2.35 | 2.36 | not | 3.8 |
| | Test C (in g/g) | | | | | | done | |
| | Fibration (visually | +++ | +++ | −−− | +++ | +++ | ++ | +++ |
| | assessed) | | | | | | | |

The fibration (formation of protein fibers similar to the muscle fibers of animal meat) is evaluated visually;
+++ excellent fibration/
++ good fibration/
+ homogeneous fibration/
− non-homogeneous fibration/
−− poor fibration/
−−− no fibration

The comparison of the various examples shows us:
the conventional textured pea proteins according to the prior art (Ex. 1 and 2) have a firmness of about 11 kg according to test A
The use of Nutralys® BF (whose solubility at pH 7 is less than 30%) as replacement for the F85G makes it possible to increase the firmness to about 15 kg, but the fibration is no longer successful.
By replacing only 30% of the F85G with the BF (Ex. 4), the fibration is very good while maintaining, surprisingly and unexpectedly, an unvaried firmness of about 15 kg.
The mere presence of a higher calcium concentration does not explain this effect (Ex. 5 and 6): it is indeed the alliance of the two proteins with high and low solubility at pH 7 and 20° C. which makes it possible to obtain this textured protein according to the invention, which is well fiberized and significantly more firm.

### Example 2: Synthesis of the Different Tests Carried Out to Obtain High-Density Textured Compositions

This section aims to exemplify a particular embodiment of the invention where the density of the textured pea protein composition produced is increased to reach a value of about 300 g/L according to test D

Examples 4 and 5 according to the invention are reproduced, but increasing the water flow rate to 7.9 and 7.5 kg/h, respectively. The pea protein compositions obtained are called Examples 8 and 9.

Examples 1 and 2 are also reproduced outside the invention, but by increasing the water flow rate to 7 and 6.9 Kg/h, respectively. The pea protein compositions obtained, called Examples 10 and 11, are characterized by the following analyses.

Example 3 is also reproduced outside the invention, but by increasing the water flow rate to 6 Kg/h. The pea protein composition obtained is called Example 12.

Table 2 below summarizes the analytical results of the textured compositions thus obtained:

TABLE 2

| | Density (g/L) | Firmness (Kg, | Water holding | |
|---|---|---|---|---|
| | according to | according to | (according to | |
| | test D) | Test A) | Test C) | Fibration |
| Ex. 8 | 320 | 32.4 | 1.4 | +++ |
| Ex. 9 | 300 | 30.4 | 1.2 | +++ |
| Ex. 10 | 320 | 19.9 | 1.7 | +++ |
| Ex. 11 | 310 | 21.2 | 1.8 | +++ |
| Ex. 12 | 320 | 30 | 0.9 | −−− |

By combining the use according to the invention of 30% of less soluble pea protein and the increase in density, firmness values according to Test A greater than 30 Kg are reached. These values are not reachable only by this density, as shown in examples Ex. 10 and Ex. 11.

### Example 3: Shear Resistance

This part aims to demonstrate the increase in the firmness of the composition according to the invention using a new test called “shear resistance.” The protocol is described below.

The device used is the following: DIGITAL MICROSCOPE_Keyence_VHX-5000 (company 2014 KEYENCE CORPORATION), equipped with VHX-5000 Ver 1.3.2.4/Ver 1.04 software

### Preparation of the Particles:

200 g+/−1 g of textured protein compositions are hydrated in water to the part with excess T°. Every 5 minutes, mix with a spoon for homogeneous hydration of all TVP. After 30 minutes, remove the water with a strainer (a mesh of approximately 1 mm).
Reserve 60 g of hydrated TVP in water at ambient temperature. Fill a Kenwood FDM30 with hydrated TVP to a volume of approximately 1.5 L. Cut the hydrated TVP in the Kenwood with a kneading blade at speed 1 for 45 s. Homogenize the mixture of particles and reserve 60 g of this first cut in water at ambient temperature.
Cut the rest of the mixture of particles in similar conditions for 105 s. Homogenize the mixture of particles and reserve 60 g of this second cut in water at ambient temperature.
With the sieve, wash the three types of products, complete hydrated TVP, cut 45 s and cut 105+45 s, for one minute each and put 10 g in TP 35.
5 TP 35 of each product is next obtained/Fill TP 35 with water at ambient temperature.
Take the Henri Julien channeled vacuum bags, 200*300 mm. Pour all of the TP 35 in the bag and two more TP 35 s of water inside. Spray the bags slightly (Bartscher vacuum machine) to store maximum air and seal it twice.

### Image Acquisition:

Select “Image stitching”:
Click “Image stitching” and then “3D.”
Chosen objective: Z20R/W/T, magnification ×50;
Mount the plate at the maximum and place the polarized filter on the microscope lens;
Turn on the screen (power) and illuminate the microscope light.
Place the samples on the microscope plate, then disperse the samples so that the particles are homogeneous before placing a glass and a weight on the area to be observed.
Click “Perform autofocus,” and then “Initialize”
Click “Measure” and set the scale at 4,000 μm (or another scale if it involves another sample).
Set the area to be analyzed and click “Set zone,” place it in the upper left corner of the green square and click “Up” and “Left,” and then position it on “Down” and “Right” of the green square, click “Down” and “Right” and click “OK”.
Set the sharpness of the area to analyze: click “Z parameter,” turn the knob of the microscope keypad to have a clear image, and position the sharpness slightly below, click “Reg lim Inf.” Do the same thing, but place the sharpness slightly above, click “Reg lim sup.”
Click “OK” and “Begin assemble” and “OK.” To assemble the image, you must wait 10 minutes.
Once finished, click “2D Visualization,” then press “Yes,” close the window and save the image.

### Image Processing:

On the photos taken, choose the automatic zone measurement and select the brightness extraction mode for the area to be measured.
Manual setting makes it possible to manually extract and select the objects on the screen that will then be measured once.
From the extracted area, numerous particles will still be bonded and parts other than the particles could have been extracted. In order to obtain only the particles, the area must be clean.
First, trim to clean the small particles; then, you can modify to separate the particles manually (to facilitate or fill based on the default values); at the least, you can remove the grains still present on the images.
Once the entire image is clean and the particles are well separated, you can measure the objects through different parameters.

The purpose of this protocol is therefore to:
Rehydrate textured protein compositions under similar conditions
Impose a similar shear on them for 45 s and 150 s
Count the number of particles generated during shearing using an optical microscope and its image processing software

The results obtained in numbers of particles are given in Table 3 and in FIG. 1:

TABLE 3

| | Shear time (s) | | |
|---|---|---|---|
| | 0 | 45 | 150 |
| Example 2 | 59 | 185 | 658 |
| Example 5 (Invention) | 45 | 110 | 448 |
| Example 3 | 34 | 74 | 398 |

It can be seen that:
Examples 5 and 3 using an insoluble protein generate about 30% less in number of particles
But Example 5 is the only one that is well fiberized and therefore compatible with similar meat applications, for example

### B) Examples Dedicated to Materials Rich in Oat Proteins

For this part, two powder mixtures were used to feed the extruder.

The first contains, as protein source, a mixture of the Nutralys® F85 pea protein isolate previously used and an oat protein isolate obtained using the method described in patent application WO2021/001478. The latter isolate has, according to test B, a solubility at pH 7 of 10%.

The second contains, as protein source, a mixture of the Nutralys® F85 pea protein isolate previously used and an oat protein isolate obtained using the method described in patent application PCT/EP2022/025003. This consists in resuspending the oat protein isolate obtained using the method described in patent application WO 2021/001478 in water, correcting the pH of said suspension to 9.5 with aqueous solution of caustic soda 1N, applying heat for 30 s at about 154° C. by direct steam injection, followed by immediate cooling at 71° C. (flash cooling), and finally freeze-drying. The latter isolate has, according to test B, a solubility at pH 7 of 81%.

Table 4 below summarizes the various mixtures of powders described above:

TABLE 4

| | Ex. 13 | Ex. 14 |
|---|---|---|
| Oat isolate according to WO2021/001478 | 15.8 | 0 |
| (solubility pH 7 <30%) | | |
| Oat isolate according to | 0 | 15 |
| PCT/EP2022/025003 (solubility pH 7 >30%) | | |
| Soluble pea protein isolate (NUTRALYS | 66.58 | 66.5 |
| F85G) (solubility pH 7 >30%) | | |
| Proatein ® | 0 | 0 |
| Internal pea fibers (PEA FIBER I50M) | 17.6 | 18.5 |

The mixtures were mixed using a planetary mixer, Hobart A200, for 10 minutes, at speed 1, with a paddle mixer. They were then extruded using a Coperion ZSK25 twin-screw extruder with an L/D=40 and a die equipped with a single hole with a diameter of 2.8 mm.

The parameters applied and monitored are summarized in Table 5 below:

TABLE 5

| | Ex. 13 | Ex. 14 |
|---|---|---|
| Powder flow rate (g/min) | 266 | 266 |
| Water flow rate (kg/h) | 34 | 40 |
| t° c. barrel 2 | 30 | 30 |
| t° c. barrel 3 | 30 | 30 |
| t° c. barrel 4 | 30 | 30 |
| t° c. barrel 5 | 30 | 30 |
| t° c. barrel 6 | 110 | 110 |
| t° c. barrel 7 | 135 | 135 |
| t° c. barrel 8 | 135 | 135 |
| t° c. barrel 9 | 96 | 96 |
| Pressure (psi) | 530 | 700 |
| Torque (%) | 27 | 27 |
| Power (kW) | 4 | 4 |
| Screw speed (rpm) | 900 | 900 |
| Knife speed (rpm) | 900 | 900 |
| SME (Kj/Kg) | 891 | 873 |

A TA HD Plus texture analyzer was used to measure the hardness of the textured compositions obtained. The compositions were rehydrated by weighing 20 grams thereof, adding 200 grams of drinking water at ambient temperature and allowing them to soak for 30 minutes by manually stirring with a spoon at 10 and 20 minutes. The excess water was then removed with a sieve. 14 grams of these rehydrated compositions was placed in a plastic container, not overlaying them but placing them in a single layer. The TA HD Plus texture analyzer is equipped with a TA-30 head was, then the samples were subjected to a 50% strain. The peak and the surface of the resulting force-time curves obtained were determined. Five measurements were carried out and the average and standard deviation were calculated. The results are presented in Table 6 below.

TABLE 6

| | | Ex. 13 | Ex. 14 |
|---|---|---|---|
| Area | Average | 16,206 | 11,668 |
| under | Standard | 590 | 847 |
| curve | deviation | | |
| Peak | Average | 3,045 | 2,315 |
| | Standard | 135 | 276 |
| | deviation | | |

It is clearly seen that the composition according to the invention (Example 14) has a peak and a greater area than Example 15 (outside the invention). Introducing an oat isolate whose solubility at pH 7 is less than 30% makes it possible to increase the firmness of the extruded protein composition.

The firmness according to test A is also achieved:

TABLE 7

| | Ex. 13 | Ex. 14 |
|---|---|---|
| Firmness according | 16.1 | 10.1 |
| to Test A | | |

This test also confirms that the textured composition obtained according to the invention is more firm.

C) Examples Dedicated to Materials Rich in Proteins Derived from faba beans:

For this part, two powder mixtures were used to feed the extruder.

The first contains, as protein source, a mixture of the Nutralys® F85 pea protein isolate previously used and a faba bean protein isolate obtained using the method described in patent application WO2020/193668. The latter isolate has, according to test B, a solubility at pH 7 of 19%.

The second contains, as protein source, a mixture of the Nutralys® F85 pea protein isolate previously used and a faba bean protein isolate obtained using the method described in patent application WO2020/193641. The latter isolate has, according to test B, a solubility at pH 7 of 60%.

The table below summarizes the various mixtures of powders described in Table 8 above:

TABLE 8

| | Ex. 15 | Ex. 16 |
|---|---|---|
| Faba bean isolate according to | 26.3 | 0 |
| WO2020/193668 (solubility pH 7 <30%) | | |
| Faba bean isolate according to | 0 | 26.3 |
| WO2020/193641. (solubility pH 7 >30%) | | |
| Soluble pea protein isolate (NUTRALYS | 61.3 | 61.3 |
| F85G) (solubility pH 7 >30%) | | |
| Internal pea fibers (PEA FIBER I50M) | 12.4 | 12.4 |

The firmness of the composition obtained according to Example 15 (according to the invention) is greater than that obtained with Example 16 (outside the invention).

### D) Example Dedicated to Producing a Chopped Steak:

To achieve this chopped steak, two primary components are necessary: textured plant protein compositions (called “hydrated TVP”) and “binder.” The first aim is to recreate the muscle fibers and the second is to make them cohesive.

The quantities of products necessary to produce each of the components are given in Table 9 below:

TABLE 9

| | INGREDIENTS | Supplier | % |
|---|---|---|---|
| Hydrated | Textured plant protein composition | Roquette | 26.50 |
| TVP | Drinking water | — | 73.50 |
| Binder | Cold drinking water 1 | — | 6.00 |
| | Cold drinking water 2 | — | 62.00 |
| | Methyl cellulose | Dow | 6.00 |
| | Sunflower oil | Lesieur | 26.00 |

Production recipe for the binder:
Disperse the amount of methyl cellulose in the amount of oil
Add the cold drinking water 1 into the Kenwood mixture and mix (maximum speed, 30 seconds with blade K), then use a spatula to return the product from the edges to the center of the Kenwood bowl.
Add the cold drinking water 2 into the Kenwood mixture and mix (maximum speed, 30 seconds with blade K), then use a spatula to return the product from the edges to the center of the Kenwood bowl. Mix for 60 seconds (maximum speed, with a blade K).
Keep the paste in a refrigerator for at least 15 minutes before use

Recipe for producing hydrated TVP:
Mix the amount of textured protein composition and the drinking water in a bowl.
Hydrate 30 minutes in a refrigerator.

Recipe for producing 1500 g of chopped steak:
Mix 900 g of hydrated TVP and 600 g of binder in a Kenwood bowl, then mix (speed 1, K blades, 4 minutes).
After 2 minutes of mixing, use a spatula to return the product from the edges to the center of the Kenwood bowl.
Form a 30 g ball by hand, giving it the form of chopped steak.
Cook in the steam oven for 6 minutes at 180° C. under 50% humidity
Freeze, then to eat, heat in the oven for 15 minutes at 180° C., turning the steak over at 7 min 30 sec

The recipe was carried out with two different sources of hydrated TVP:
NUTRALYS® T70S, which corresponds to the compositions of Examples 1 and 2,
The textured protein composition obtained according to Example 8

The firmness is then analyzed using a TAXT texturometer, the analysis parameters of which are as follows:
The knife equipping the machine is of reference TA045
The analysis parameters are:
   Test mode: Compression
   Pre-test speed: 2 mm/sec
   Test speed: 10 mm/sec
   Post-test speed: 10 mm/sec
   Target mode: Strain
   Strain: 75%
   Trigger type: Auto (force)
   Trigger force: 0.098 N
   Break mode: off
   Stop Plot At: Start position
   Tare mode: Auto
   Advanced options: On
The value obtained is called “firmness” and is indicated in grams

The results obtained are as follows:

| Source of hydrated TVP | |
|---|---|
| used in chopped steak | Firmness (g) |
| NUTRALYS ® T70S (ROQUETTE) | 585 |
| Textured composition | 908 |
| according to Example 8 | |

The chopped steak obtained with the textured composition according to the invention is therefore 1.5 times more firm than that obtained with the conventional textured composition.

1. A method for producing a composition of plant proteins textured in a dry process, in particular oat proteins textured in a dry process, rice proteins textured in a dry process, or legume proteins textured in a dry process, in particular chosen between pea and faba bean proteins, even more preferentially pea proteins, wherein the method comprises the following steps:
1) Providing a mixture comprising a first material rich in plant proteins, in particular oat, rice or legume proteins in particular chosen from peas or faba beans, whose solubility in water at pH 7 and 20° C. is greater than or equal to 30% and a second material rich in plant proteins, in particular oats, rice or leguminous plants, in particular chosen from peas or faba beans, whose solubility in water at pH 7 and 20° C. is less than 30%, having a respective dry weight ratio of the first material rich in plant proteins to the second material rich in plant proteins ranging between 60/40 and 90/10, preferentially between 70/30 and 80/20;
2) Extrusion cooking said mixture with water, the water to mixture mass ratio before cooking ranging between 5% and 25%, preferentially between 5% and 20%, preferentially between 5% and 15%, preferentially between 10% and 15%, even more preferentially 10%;
3) Optionally cutting the extruded composition using a knife at the outlet of the extruder consisting of an outlet die with orifices; and,
4) Drying the composition thus obtained, wherein a material rich in proteins corresponds to a material comprising at least 25% of proteins, the solubility of the materials rich in proteins being measured according to Test B.

2. The method according to claim 1, wherein the leguminous protein is not a soybean protein.

3. The method according to claim 1, wherein the materials rich in proteins used for step 1 are isolates, whose protein content is greater than 80% by weight.

4. The method according to claim 1, wherein the material rich in proteins having a solubility in water at pH 7 and 20° C. of less than 30% has a water holding capacity of less than 4 grams per gram of material rich in proteins, the water holding capacity being measured according to Test C.

5. The method according to claim 1, wherein the materials rich in plant proteins are characterized by a particle size characterized by a Dmode ranging between 150 microns and 400 microns, preferentially between 150 microns and 200 microns or between 350 microns and 450 microns.

6. The method according to claim 1, wherein the mixture of step 1) also comprises plant fibers, with a dry weight ratio of plant proteins to plant fibers ranging from 70/30 to 90/10, preferentially from 75/25 to 85/15.

7. The method according to claim 6, wherein the plant fiber contains between 40% and 60% of polymers made up of cellulose, hemicellulose and pectin, preferentially between 45% and 55%, as well as between 25% and 45% of pea starch, preferentially between 30% and 40%.

8. A composition comprising proteins, preferentially chosen from oat, rice, pea and faba bean proteins, even more preferentially pea and faba bean, textured by dry extrusion in the form of particles, capable of being obtained by the method according to claim 1.

9. The composition according to claim 8, wherein its density is between 60 and 320 g/L, preferentially between 70 and 280 g/L, the density being determined according to test D.

10. The composition according to claim 8, wherein its density is between 60 and 150 g/L, preferentially between 70 and 130 g/L, the density being determined according to test D.

11. The composition according to claim 8, wherein its density is between 280 and 320 g/L, preferentially between 290 and 310 g/L, the density being determined according to test D.

12. The composition according to claim 8, wherein the content within the composition ranges between 60% and 80% by dry weight, preferentially between 70% and 80% by dry weight relative to the total weight of dry matter of the composition.

13. The composition according to claim 8, wherein it has a dry matter content greater than 80% by weight, preferentially greater than 90% by weight.

14. The composition according to claim 8, wherein its calcium ion content is preferentially less than 0.5% by dry weight on dry weight, preferentially less than 0.45%, preferentially ranging from 0.3% to 0.45%.

15. A use of the legume protein composition textured in a dry process capable of being obtained by the method according to claim 1 in industrial applications, preferably in the human and animal food industry, industrial pharmaceuticals or cosmetics.

16. Use of the legume protein composition textured in a dry process capable of being obtained by the method according to claim 1 in industrial applications, preferably in the production of meat analogs, in particular in the production of sausages, ground meat, burgers, chicken nuggets, or chicken.
